(19) United States
(12) Patent Application Publication
(10) Pub. No.: US 2009/0239004 A1
(43) Pub. Date: Sep. 24, 2009

(54) MEDIA SHEET FOR INKJET PRINTING

(76) Inventor: Yagiang Ming, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/050,370

(22) Filed: Mar. 18, 2008

(51) Int. Cl. B41M 5/50; B05D 5/00

(52) U.S. Cl. 428/32.37; 427/372.2; 427/256; 427/385.5

(57) ABSTRACT

Disclosed is a media sheet for inkjet printing. The media sheet includes a porous substrate and a flocculent formulation disposed on the porous substrate. The flocculent formulation includes at least one cationic organic flocculant, at least one organic acid and a solvent. The media sheet used herein helps in improving the printing quality of images generated thereon. Further, methods for preparing such a media sheet that includes the porous substrate and the flocculant formulation disposed on the porous substrate are disclosed.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

The present invention relates to porous media sheets for inkjet printing for generating images of an improved printing quality.

2. Description of the Related Art

Inkjet printing has been one of the most widely used techniques for both commercial and non-commercial printing applications. The use of the inkjet printing has enormously increased in industrial applications. Such industrial applications include, but are not limited to, printing of textiles, envelopes, and newspapers. Depending on various industrial applications and printing requirements, different types of substrates have been used for inkjet printing. Suitable examples of such substrates include, but are not limited to, textiles substrates, non-woven substrates, canvas substrates, and cellulose substrates. In general, the substrates are made of porous materials and are hereinafter referred to as “porous substrates.” The porous materials may include micro-porous materials to macro-porous materials, since the porous materials may be manufactured with different pore sizes. Examples of the porous materials include cotton, cellulose, silk, polyester, nylon, and similar porous materials.

In inkjet printing, the porous substrates are printed using either dye-based inks or pigment-based inks. The dye-based inks include a dye, which is dissolved in water-soluble colored liquids. However, when the dye-based ink is used for printing images on the porous substrates, the presence of the water-soluble dye molecules deteriorate after an exposure to UV light and other environmental factors such as atmospheric gases. Consequently, the images printed on the porous substrates undergo deterioration and fade away. On the contrary, the pigment-based inks include pigments that are inert and do not fade away easily even after a prolonged exposure to UV light and other environmental factors. Therefore, the use of the pigment-based inks is preferred over the use of the dye-based inks for inkjet printing. However, the pigment-based inks contain pigment particles that tend to penetrate inside the porous substrates after inkjet printing, thereby affecting the printing quality of the images generated on the porous substrates.

In order to generate images of improved printing quality, the pigment-based inks may be formulated to include additional agents such as cationic polymers and metal salts, etc, which may immobilize the pigment particles on the porous substrates, thereby resulting in the generation of images of improved printing quality that do not fade away easily. However, the additional agents may reduce the shelf life of the ink and cause poor jetting of the ink on the porous substrates. Additionally, for a particular type of a porous substrate and the respective inkjet printing application, specific pigment-based ink formulations have to be prepared to generate images of an improved printing quality, which contributes to a high cost.

Therefore, to improve ink shelf life and jetting of the ink on the porous substrates, and to reduce the incurred cost, various combinations of the additional agents have been used to prepare formulations that may also be disposed directly on the porous substrates using conventional techniques, such as coating, jetting, and impregnation, prior to inkjet printing. By applying a formulation of the additional agents directly to the porous substrates, diverse types of pigment-based inks may be used while inkjet printing.

However, the total cost of these formulations varies depending on the type of the additional agents used in the formulations and methods used for disposing the formulations on the porous substrates. For example, the use of an expensive additional agent in the formulations and a conventional coating technique for disposing the formulations accordingly may increase the total cost of the formulations. Further, the cost of the porous substrates tends to increase with a subsequent increase in the complexity of the formulations used.

Additionally, the conventional coating techniques that are used to dispose diverse formulations of the additional agents on porous substrates as obtained after a manufacturing process are time-consuming techniques. The increase in time needed to dispose the formulations on the manufactured porous substrates further increases the overall cost of the porous substrates. Therefore, it has always been a challenge to prepare a formulation to be disposed on a porous substrate that helps in immobilizing an ink on a surface of the porous substrate for generating images of an improved printing quality, and at the same time, is economical.

The above-mentioned drawbacks avert a broad use of a porous substrate that includes a formulation of varied additional agents for generating images of an improved printing quality.

Moreover, a conventional impregnation technique used for disposing a formulation on both sides of a porous substrate that exhibits a low mechanical strength or a low porosity may not be effectively employed. More specifically, rewetting of the porous substrate during impregnating the formulation thereon further deteriorates the mechanical strength and porosity of the porous substrate. A traditional cellulose-based paper substrate is an example of such a porous substrate that exhibits low mechanical strength and porosity. However, a porous substrate made from a material such as polyester, nylon, and the like, exhibits good mechanical strength and porosity. Therefore such a porous substrate may be used for impregnating the formulation on both sides. Nonetheless, to impregnate both sides of the porous substrate effectively and economically at a high speed, it is desirable to employ a cost-effective formulation. Therefore, it is desirable to manufacture a cost-effective, high quality, and a dual side printable porous substrate having a formulation disposed thereon.

Accordingly, there is a need for a formulation to be disposed on a porous substrate for generating images of an improved printing quality in a reliable and a cost-effective manner. Additionally, there is a need for an improved method for disposing the formulation on the porous substrate.

### SUMMARY OF THE INVENTION

In view of the foregoing disadvantages inherent in the prior art, the general purpose of the present invention is to provide a media sheet for use in inkjet printing and methods for preparing the media sheet, to include all the advantages of the prior art, and to overcome the drawbacks inherent therein.

In one aspect, the present invention provides a media sheet for use in inkjet printing. The media sheet includes a porous substrate and a flocculant formulation disposed on at least one side of the porous substrate. The flocculent formulation includes about 1 to about 20 parts by weight of at least one cationic organic flocculant. Further, the flocculant formulation includes about 0.01 to about 10 parts by weight of at least one organic acid. The media sheet is capable of serving as an effective receptor for inkjet printing.

In another aspect, the present invention provides a method for preparing a media sheet for use in inkjet printing. The method includes preparing a flocculent formulation by adding and mixing about 1 to about 20 parts by weight of at least one cationic organic flocculent, about 0.01 to about 10 parts by weight of at least one organic acid, and less than or equal to about 98 parts by weight of a solvent. Further, the method includes disposing the prepared flocculant formulation on a porous substrate. Furthermore, the method includes drying the flocculant formulation disposed on the porous substrate.

### DETAILED DESCRIPTION

It is understood that various omissions and substitutions of equivalents are contemplated as circumstances may suggest or render expedient, but these are intended to cover the application or implementation without departing from the spirit or scope of the claims of the present invention. It is to be understood that the present invention is not limited in its application to the details of components set forth in the following description. The present invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

As used herein, the term “flocculant formulation” refers to a flocculant-based composition that is disposed on a porous substrate prior to inkjet printing.

As used herein, the term “pigment” refers to an insoluble colorant formed of small solid particles. The pigment is used in a pigment-based ink for inkjet printing. Hereinafter, the pigment-based ink may interchangeably be referred to as an “ink.” The ink may include multiple colorants.

As used herein, the term “bleeding” refers to either mixing of colorants or absorption of colorants present in an ink, on a surface of a porous substrate. Such a mixing or absorption of colorants on the surface of the porous substrate results in the generation of images of a poor printing quality.

The present invention provides a media sheet that includes a porous substrate and a flocculent formulation disposed on the porous substrate for use in inkjet printing. Further, the present invention provides methods for preparing the media sheet by disposing the flocculant formulation on the porous substrate. The flocculant formulation may be disposed on at least one side of the porous substrate by means of either a coating method or a jetting method. Alternately, the flocculent formulation may be disposed into the porous substrate using an impregnation method.

The porous substrate used in the media sheet is a suitable receptor for receiving an ink dispensed by a particular type of inkjet printer. Suitable examples of the porous substrate include, but are not limited to, textiles substrates, non-woven substrates, canvas substrates, and lingo-cellulose substrates. Further, the porous substrate may be made of materials as known to those skilled in the art, wherein the materials include cotton, silk, paper, polyester, nylon, and similar porous substrates. Furthermore, the porous substrate may be available in the form of a sheet, a membrane, or a film. In addition, pore size and pore volume of the porous substrate may be adjusted to correctly hold the volume of the ink that ensures the generation of images of an improved printing quality.

The flocculant formulation disposed on the porous substrate, includes at least one cationic organic flocculant and a solvent, and other components. Further, the flocculant formulation may include at least one organic acid.

In one embodiment of the present invention, the flocculant formulation may be prepared by adding and mixing about 1 to about 20 parts by weight of the at least one cationic organic flocculant and less than or equal to about 98 parts by weight of the solvent. More specifically, the flocculant formulation may include about 2.5 to about 5 parts by weight of the at least one cationic organic flocculant.

The cationic organic flocculant used in the flocculant formulation may include one or more positive charges. While printing the media sheet with an ink, the flocculant formulation interacts with pigment present in the ink. More specifically, the cationic organic flocculant interacts with small solid particles that are present in the ink. The cationic organic flocculant helps in bringing together a population of the small solid particles to form “flocs” over the media sheet. Such flocs are small masses formed either through coagulation or agglomeration of the small solid particles. In addition, the small solid particles may include zero or more positive or negative charges, which may interact with the cationic organic flocculant to facilitate the formation of the flocs. The formation of the flocs contributes to stabilizing and immobilizing the small solid particles over the media sheet. This stabilization and immobilization of the small solid particles results in fixing of the pigment over the media sheet, thereby eliminating effects such as color bleeding and smearing, in order to generate images of improved printing quality.

Suitable examples of the cationic organic flocculant used in the flocculant formulation include, but are not limited to, polyamines, quaternized polyamines, polyguanidines, polyethyleneimine, polyvinylpyridine, polyvinylamine, polyallyamine, poly(N,N-dimethyl 2-hydroxypropylene ammonium chloride), poly(4-vinyl 1-methyl-pyridinium bromide), polydiallydimethylammonium chloride, copolymers of quaternized vinylimidazole and polyquaternium, and combinations thereof. Guanidine-formaldehyde polymer, methanesulfonate salt; dimethylamine-epichlorohydrin polymer; and combinations thereof, are more specific examples of the cationic organic flocculant used in the flocculant formulation of the present invention.

The flocculent formulation may include about 0.01 to about 10 parts by weight of at least one organic acid to adjust pH of the flocculant formulation. More specifically, the flocculent formulation may include about 0.5 to about 5 parts by weight of the at least one organic acid. Suitable examples of the organic acid include, but are not limited to, benzoic acid, citric acid, glycolic acid, succinic acid, acetic acid, tartaric acid, and 2-furancarboxylic acid.

Suitable examples of the solvent used in the flocculant formulation include, but are not limited to, water, alcohol, and a combination thereof. More specifically, deionized water may be used as the solvent. The solvent allows dissolution of the cationic organic flocculent to form a uniform solution. Further, the solvent suspends the cationic organic flocculent in the uniform solution such that the uniform solution may acquire either a liquid or a semisolid appearance. However, without departing from the scope of the present invention, the solvent may further suspend various other components of the flocculent formulation that may be included to impart additional properties to the flocculant formulation.

In addition to the foregoing components, the flocculant formulation may include an additive. The additive may be included to avoid problems that occur while preparing the flocculant formulation by adding and mixing various components and while disposing the prepared flocculent formulation on the porous substrate. Such problems include, but are not limited to, improper wetting of the surface of the porous substrate, foaming of the flocculant formulation when exposed to high mixing rates, improper adhesion of the flocculant formulation to the porous substrate. Suitable examples of the additive include, but are not limited to, multivalent metal salts, surfactant compositions, humectants, pH adjusting agents, viscosity control agents, foam control agents, stabilizers, antioxidants, biocides, and combinations thereof.

One or more multivalent metal salts may be used in the flocculent formulation for precipitating the small solid particles in the ink. It should be apparent to a person skilled in the art that the multivalent metal salts include cations and anions that are included as counterions of the cations used in the multivalent metal salts.

Suitable examples of the cations include, but are not limited to, alkaline earth metals of Group 2A of the Periodic Table, transition metals of Group 3B of the Periodic Table, and elements of Group 3A of the Periodic Table. Suitable examples of the anions include, but are not limited to, nitrates, nitrites, benzoates, titrates, formates, tartrates, thiocyanates, sulfates, sulfites, bisulfites, alkanesulfonates, fluoroalkanesulfonates, perchlorates, halides, pseudo-halides, acetates, and propionates.

Specific examples of the multivalent metal salts that may be used in the flocculent formulation include, but are not limited to, aluminum sulfate, aluminum nitrate, aluminum chloride, calcium chloride, calcium acetate hydrate, calcium propionate, calcium bromide, magnesium chloride, magnesium sulfate, magnesium acetate tetrahydrate, gallium nitrate, ferrous sulfate, chromium sulfate, zinc sulfate, zinc acetate, zinc chloride, and combinations thereof.

Moreover, the use of few of the foregoing multivalent metal salts that are economical may help in reducing the overall cost of the media sheet without compromising the quality of the images generated thereon.

A surfactant composition used in the flocculent formulation helps in adjusting surface tension of the flocculent formulation. Preferably, the flocculent formulation has a surface tension ranging from about 20 to about 70 dyne per centimeter. Further, the surfactant composition may impart wetting properties to the media sheet. Furthermore, during the inkjet printing of the media sheet, when the flocculant formulation interacts with the ink, the surfactant composition of the flocculant formulation may charge the small solid particles present in the pigment of the ink. The surfactant composition may include an anionic surfactant, a cationic surfactant, an amphoteric surfactant, a nonionic surfactant, and combinations thereof. Suitable examples of the surfactant composition include, but are not limited to, a fluorocarbon-based surfactant, a silicon-based surfactant, a hydrocarbon-based surfactant, and a combination thereof. In one embodiment, a hydrocarbon surfactant of a fatty acid may be used as the hydrocarbon-based surfactant in the present invention.

The use of the humectants helps prevent the flocculent formulation from drying out or crushing when disposed from an inkjet head of an inkjet printer over the porous substrate. Useful humectants include, but are not limited to, polyhydric alcohols such as ethylene glycol, diethylene glycol, triethylene glycol, propylene glycol, tetraethylene glycol, polyethylene glycol, glycerol, 2-methyl-2,4-pentanediol, 2-ethyl-2-hydroxymethyl-1,3-propanediol, 1,5 pentanediol, 1,2-hexanediol, 1,2,6-hexanetriol and thioglycol; lower alkyl mono-or di-ethers derived from alkylene glycols such as ethylene glycol mono-methyl or mono-ethyl ether, diethylene glycol mono-methyl or mono-ethyl ether, propylene glycol mono-methyl or mono-ethyl ether, triethylene glycol mono-methyl, mono-ethyl or mono-butyl ether, diethylene glycol di-methyl or di-ethyl ether, poly(ethylene glycol) monobutyl ether, and diethylene glycol monobutylether; nitrogen-containing compounds, such as urea, 2-pyrrolidinone, N-methyl-2-pyrrolidinone, and 1,3-dimethyl-2-imidazolidinone; sulfur-containing compounds such as 2,2′-thiodiethanol, dimethyl sulfoxide and tetramethylene sulfone; and combinations thereof. Specific examples of the humectants may include ethyl alkyldiol, glycol, and glycerol.

The flocculant formulation may include additional pH adjusting agents for regulating and thereby maintaining pH of the flocculant formulation. Cationic organic salts may be used in the flocculant formulation as the pH adjusting agents. 4-Methylmorpholine N-Oxide is a suitable pH adjusting agent for use in the flocculant formulation. However, without departing from the scope of the present invention, any buffer that is characterized as cationic in nature may be used as the pH adjusting agent. The positive charge of the pH adjusting agent stabilizes the small solid particles present in the pigment over the surface of the media sheet. For the purpose of this description, the use of the pH adjusting agent renders the flocculant formulation to have a pH of less than or equal to about 7.

The viscosity control agents used in the flocculant formulation may include, but are not limited to, cellulose, derivatised cellulose, starch, wheat paste, acrylic resins, and combinations thereof. However, it should be apparent to the person skilled in the art that to control the viscosity of the flocculant formulation, the solvents of the present invention may also act as the viscosity control agents.

The flocculant formulation of the present invention may have a viscosity ranging from about 2 to about 5000 centipoise, or, more specifically, from about 2 to about 2000 centipoise, or, even more specifically, from about 2 to about 1000 centipoise. However, it should be apparent to one skilled in the art that the desired viscosity range varies with respect to the method for disposing the flocculant formulation. In one embodiment of the present invention, the flocculant formulation disposed on the porous substrate using a coating method, may have a viscosity ranging from about 50 to about 2000 centipoise. In another embodiment of the present invention, the flocculant formulation disposed on the porous substrate using a jetting method, may have a viscosity ranging from about 2 to about 10 centipoise. In yet another embodiment of the present invention, the flocculant formulation disposed into the porous substrate using an impregnation method, may have a viscosity ranging from about 10 to about 500 centipoise.

As mentioned-above, conventional coating, jetting, and impregnation methods may be used for disposing the flocculant formulation on the porous substrate in order to prepare the media sheet of the present invention.

In one embodiment of the present invention, a method used for preparing a media sheet may include preparing a flocculant formulation by adding and mixing a quantity of a cationic organic flocculant, a quantity of an organic acid, and a quantity of a solvent. The quantity of the cationic organic flocculant may vary from about 1 to about 20 parts by weight. The quantity of the organic acid may vary from about 0.01 to about 10 parts by weight. The quantity of the solvent may vary from less than or equal to about 98 parts by weight.

Further, the method may include disposing the above-prepared flocculant formulation on the porous substrate. The flocculant formulation may be disposed on at least one side of the porous substrate by a coating technique. Examples of the coating technique may include, but are not limited to, rod coating, knife coating, blade coating, roll-coating, reverse roll coating, gravure coating, curtain coating, rotary screen coating, and slot coating. Further, the foregoing examples of the coating technique may include the use of an air knife coater, a blade coater, a gate roll coater, a doctor blade, a Meyer rod, a roller, a reverse roller, a gravure coater, a brush applicator, a sprayer, a slot coater, and the like.

Furthermore, the method may include drying the flocculant formulation disposed on the porous substrate using techniques that include hot air convection, microwave, infrared heating, heat lamp, open air-drying, and other such similar techniques. It should be apparent to a person skilled in the art that the method may include drying the media sheet that includes the flocculant formulation disposed thereon

In another embodiment of the present invention, the method used for preparing the media sheet may include disposing the flocculant formulation into the porous substrate using an impregnation technique. The impregnation technique may include dipping the porous substrate into a solution of the flocculant formulation. Subsequently, the dipped porous substrate may be squeezed in order to remove the excess quantity of the flocculant formulation from the porous substrate.

However, it should be apparent to a person skilled in the art that the flocculant formulation may be disposed on both sides of the porous substrate using the coating technique or the impregnation technique.

Without departing from the scope, the present invention also discloses that the flocculant formulation may be disposed during manufacturing of the porous substrate using the foregoing method. More specifically, during a final stage of the manufacturing of the porous substrate, a separate coating or an impregnation station may be installed for disposing the flocculant formulation either on one side or both sides of the porous substrate. Further, such an installation station may provide a means for drying the flocculant formulation disposed on the porous substrate. In the aforementioned manner, it is possible to prepare a cost-effective, high quality, and a dual side printable media sheet of the present invention.

In another embodiment of the present invention, the method used for preparing the media sheet may include disposing the flocculant formulation on the porous substrate using a jetting technique. The jetting technique may include filling the flocculant formulation in an ink-free cartridge, and subsequently, jetting the flocculant formulation filled in the ink-free cartridge on at least one side of the porous substrate. The flocculant formulation may be jetted on the porous substrate using an inkjet printer. The jetted porous substrate and the flocculant formulation present on the jetted porous substrate, collectively, form the media sheet, which is ready to be printed with an ink.

However, it should be apparent to a person skilled in the art that the flocculant formulation, used in the method that employs the jetting technique, is characteristic of a low viscosity in order to maintain a consistent flow rate during the transfer from the inkjet printer to the porous substrate. The said property of the flocculant formulation renders the method to serve as a well-equipped and a high-speed method for preparing the media sheet.

The description of the present invention is further illustrated by the following non-limiting examples. However, one of ordinary skill in the art, and based on a reading of this detailed description, would recognize that, the specific examples are intended to illustrate, not limit, the scope of the present invention.

In the below-mentioned examples, “Jet print Photo Canvas,” “Jacquard Inkjet Cotton and silk,” and “MCG Paper Cotton Cloth Canvas” are trade designations of exemplary porous substrates that were used for conducting experiments to verify the efficiency of a flocculant formulation provided by the present invention.

Further, as used in the below-mentioned examples, the term “control” refers to a respective porous substrate for each of the porous substrates used in Table 2 and Table 3 that does not include the Flocculant Formulation.

### EXAMPLE 1

In the following example, a flocculant formulation hereinafter referred to as “Flocculant Formulation I,” was disposed on a group of porous substrates using a coating method. Each one of the porous substrates on which the Flocculant Formulation I was disposed may interchangeably be referred to as the porous substrates treated with the Flocculant Formulation I. Table 1 shows a composition for the Flocculant Formulation I. Further, the Flocculant Formulation I was characterized by a pH of about 4, a viscosity of about 4 centipoise, and a surface tension of about 23 dyne per centimeter. The pH of the Flocculant Formulation I was adjusted using an organic acid.

TABLE 1

| | Parts by |
|---|---|
| Components | weight (%) |
| Guanidine-formaldehyde polymer, methanesulfonate salt | <2.5 |
| (cationic polymer) | |
| Dimethylamine-epichlorohydrin polymer, methanesulfonate | <2.5 |
| salt (cationic polymer) | |
| Ethyl alkyldiol (2-ethyl-2-(hydroxy ethyl-1,3-propanediol)) | <20 |
| Heteromonocycle, 4-methyl-, 4-oxide, methanesulfonate (4- | <10 |
| methylmorpholine-N-Oxide) | |
| Heteromonocycle, 4-methyl, 4-oxide | <2.5 |
| Water | <60 |
| Other Additives | <2.5 |

The group of the porous substrates used herein included Jet print Photo Canvas, Jacquard Inkjet Cotton and silk, and MCG Paper Cotton Cloth Canvas. The Flocculant Formulation I was coated on a back side of each of the porous substrates using a rod. Subsequently, the coated porous substrates were air-dried. The air-dried coated porous substrates were then printed with an ink using a pigment printer. The ink used herein included a black colorant, a cyan colorant, a magenta colorant, and a yellow colorant that were filled in an empty cartridge for use in inkjet printing. Subsequent to conducting the inkjet printing, measurements for optical density and gamut for each of the colorants present in the ink, and the measurements for a parameter, “L*ₘᵢₙ,” for the porous substrates were carried-out to verify the efficiency of the Flocculant Formulation I. Accordingly, the measurements for the optical density, gamut, and L*ₘᵢₙ are illustrated in Table 2.

TABLE 2

| | | Optical Density | | | | | |
|---|---|---|---|---|---|---|---|
| Porous Substrates | | Black | Cyan | Magenta | Yellow | Gamut | L*ₘᵢₙ |
| Jet Print | Control | 1.03 | 0.64 | 0.63 | 0.75 | — | — |
| Photo Canvas | Treated with | 1.37 | 0.88 | 0.87 | 1.13 | — | — |
| | Flocculant | | | | | | |
| | Formulation I | | | | | | |
| MCG Paper | Control | 1.21 | 0.66 | 0.71 | 0.87 | 77 | 28.3 |
| Cotton Cloth | Treated with | 1.37 | 0.82 | 0.84 | 1.12 | 117 | 24 |
| Canvas | Flocculant | | | | | | |
| | Formulation I | | | | | | |
| Jacquard | Control | 1.32 | 0.72 | 0.75 | 0.89 | — | — |
| Inkjet Cotton and | Treated with | 1.47 | 0.83 | 0.83 | 1.11 | — | — |
| Silk | Flocculant | | | | | | |
| | Formulation I | | | | | | |

From Table 2, with respect to measurements for the optical density and gamut for each of the colorants present in the ink, it can be seen that the respective values of the optical density and gamut are higher for the ink, which is used on the porous substrates treated with the Flocculant Formulation I than the respective values of the optical density and gamut for the ink used on the control porous substrates, which do not include the Flocculant Formulation I. Further, the value for the L*ₘᵢₙ for the MCG Paper Cotton Cloth Canvas treated with the Flocculant Formulation I is lower than the value of L*ₘᵢₙ for the control MCG Paper Cotton Cloth Canvas, which indicates an improvement in the intensity of the black colorant on the porous substrate.

### EXAMPLE 2

In the following example, the Flocculant Formulation I (Table 1) was disposed on a group of porous substrates using a jetting method. The group of the porous substrates used herein included Jet print Photo Canvas and MCG Paper Cotton Cloth Canvas. The jetting method included filling the Flocculant Formulation I in an ink-free cartridge and disposing the Flocculant Formulation I filled in the ink-free cartridge on a back side of each of the porous substrates. Subsequently, the porous substrates, treated with the Flocculant Formulation I, were printed using a pigment printer. The pigment printer included an ink such as the ink that was used in Example 1. Subsequent to conducting the inkjet printing, measurements for the optical density for each of the colorants present in the ink was carried-out to verify the efficiency of the Flocculant Formulation I. Measurements for the optical density of each of the colors present in the ink used for printing are illustrated in Table 3.

TABLE 3

| | | Optical Density | | | |
|---|---|---|---|---|---|
| Porous Substrates | | Black | Cyan | Magenta | Yellow |
| Jet Print | Control | 0.87 | 0.59 | 0.57 | 0.67 |
| Photo Canvas | Treated with | 1.3 | 0.85 | 0.85 | 1.12 |
| | Flocculant | | | | |
| | Formulation I | | | | |
| MCG Paper | Control | 1.24 | 0.66 | 0.74 | 0.91 |
| Cotton Cloth | Treated with | 1.37 | 0.84 | 0.87 | 1.12 |
| Canvas | Flocculant | | | | |
| | Formulation I | | | | |

From Table 3, with respect to measurements of the optical density for each of the colorants present in the ink, it can be seen that the respective values of the optical density are higher for the ink that is used on the porous substrates treated with the Flocculant Formulation I than the respective values of the optical density for the ink used on the control porous substrates that do not include the Flocculant Formulation I.

For the purpose of this description, the media sheet that includes a porous substrate and a flocculant formulation disposed thereon serves as an effective ink receptor for use in inkjet printing. The flocculant formulation includes at least one cationic organic flocculant that enables stabilization and immobilization of small solid particles present in a pigment of an ink over the porous substrate. The ability of the flocculant formulation to stabilize and immobilize the small solid particles helps in generating images of improved printing qualities. However, it should be obvious to persons skilled in the art that the efficiency of the flocculant formulation of the present invention depends on the ink composition and chemistry. Nonetheless, the use of the flocculant formulation of the present invention on diverse porous substrates allows for a wide use of the media sheet for different applications. Further, the flocculant formulation disposed on the porous substrates may include flocculants to help preparing a cost-effective media sheet. In another aspect of the present invention, the methods for the preparation of the media sheet that serve as effective and improved methods for disposing the flocculant formulation on the porous substrate prior to inkjet printing.

The foregoing description of several embodiments and methods of the present invention have been presented for purposes of illustration. It is not intended to be exhaustive or to limit the present invention to the precise steps and/or forms disclosed, and obviously many modifications and variations are possible in light of the above teaching. It is intended that the scope of the present invention be defined by the claims appended hereto.

What is claimed is:

1. A media sheet for inkjet printing, the media sheet comprising:
a porous substrate; and
a flocculant formulation disposed on at least one side of the porous substrate, the flocculant formulation comprising,
about 1 to about 20 parts by weight of at least one cationic organic flocculant, and
about 0.01 to about 10 parts by weight of at least one organic acid.

2. The media sheet of claim 1 wherein the at least one cationic organic flocculant is selected from the group consisting of polyamines, quatemized polyamines, polyguanidines, polyethyleneimine, polyvinylpyridine, polyvinylamine, polyallyamine, poly(N,N-dimethyl 2-hydroxypropylene ammonium chloride), poly(4-vinyl 1-methyl-pyridinium bromide), polydiallydimethylammonium chloride, copolymers of quaternized vinylimidazole and polyquaternium, and combinations thereof.

3. The media sheet of claim 1 wherein the at least one organic acid is selected from the group consisting of benzoic acid, citric acid, glycolic acid, succinic acid, acetic acid, tartaric acid, and 2-furancarboxylic acid.

4. The media sheet of claim 1 wherein the porous substrate is selected from the group consisting of a textile substrate, a non-woven substrate, a lingo-cellulose substrate, and a canvas substrate.

5. The media sheet of claim 1 wherein the porous substrate comprises at least one of cotton, silk, polyester, nylon, paper, and combinations thereof.

6. The media sheet of claim 1 wherein the flocculant formulation has a viscosity of about 2 to about 5000 centipoise and a surface tension of about 20 to about 70 dyne per centimeter.

7. The media sheet of claim 1 wherein the flocculant formulation further comprises an additive selected from the group consisting of multivalent metal salts, surfactant compositions, humectants, viscosity control agents, foam control agents, stabilizers, antioxidants, pH adjusting agents, biocides, and combinations thereof.

8. The media sheet of claim 1 wherein the flocculant formulation has a pH of less than or equal to about 7.

9. The media sheet of claim 1 wherein the flocculant formulation further comprises less than or equal to about 98 parts by weight of a solvent.

10. A method for preparing a media sheet for inkjet printing, the method comprising:
preparing a flocculant formulation by adding and mixing about 1 to about 20 parts by weight of at least one cationic organic flocculant, about 0.01 to about 10 parts by weight of at least one organic acid, and less than or equal to about 98 parts by weight of a solvent;
disposing the flocculant formulation on a porous substrate; and
drying the flocculant formulation disposed on the porous substrate.

11. The method of claim 10 wherein disposing the flocculant formulation on the porous substrate comprises coating the flocculant formulation on at least one side of the porous substrate.

12. The method of claim 11 wherein the flocculant formulation has a viscosity of about 50 to about 2000 centipoise and a surface tension of about 20 to about 70 dyne per centimeter.

13. The method of claim 10 wherein disposing the flocculant formulation on the porous substrate comprises:
impregnating the flocculant formulation into the porous substrate by dipping the porous substrate into the flocculant formulation; and
squeezing the dipped porous substrate.

14. The method of claim 13 wherein the flocculant formulation has a viscosity of about 10 to about 500 centipoise and a surface tension of about 20 to about 70 dyne per centimeter.

15. The method of claim 10 wherein disposing the flocculant formulation on the porous substrate comprises:
filling the flocculant formulation in an ink-free cartridge; and
jetting the flocculant formulation filled in the ink-free cartridge on at least one side of the porous substrate by an inkjet printer.

16. The method of claim 15 wherein the flocculant formulation has a viscosity of about 2 to about 10 centipoise and a surface tension of about 20 to about 70 dyne per centimeter.

17. The method of claim 10 wherein the at least one cationic organic flocculant is selected from the group consisting of polyamines, quatemized polyamine, polyguanidines, polyethyleneimine, polyvinylpyridine, polyvinylamine, polyallyamine, poly(N,N-dimethyl 2-hydroxypropylene ammonium chloride), poly(4-vinyl 1-methyl-pyridinium bromide), polydiallydimethylammonium chloride, copolymers of quaternized vinylimidazole and polyquaternium, and combinations thereof.

18. The method of claim 10 wherein the at least one organic acid is selected from the group consisting of benzoic acid, citric acid, glycolic acid, succinic acid, acetic acid, tartaric acid, and 2-furancarboxylic acid.
